(19) United States
(12) Patent Application Publication
(10) Pub. No.: US 2026/0356429 A1
(43) Pub. Date: Nov. 12, 2026

(54) VEHICLE PROTECTION ASSEMBLIES

(71) Applicant: Rivian IP Holdings, LLC, Irvine, CA (US)

(72) Inventors: Sharbel ELKANTATI, Windsor (CA); Tripur Udhav MAHAJAN, Irvine, CA (US); Adam Richard BALLARD, Corona, CA (US); Ryan ARENS, Irvine, CA (US)

(21) Appl. No.: 19/201,832

(22) Filed: May 7, 2025

(51) Int. Cl. B62D 21/10; B29C 45/14; B29K 705/02; B29L 31/30; B32B 3/26; B32B 5/02; B32B 5/26; B32B 15/14; B32B 15/20; B62D 29/04

(52) U.S. Cl. CPC B62D 21/10; B29C 45/14467; B32B 3/266; B32B 5/02; B32B 5/26; B32B 15/14; B32B 15/20; B29C 2045/14532; B29K 2705/02; B29L 2031/3005; B32B 2571/00; B32B 2605/00; B62D 29/041

(57) ABSTRACT

Vehicle protection assemblies and methods of manufacturing vehicle protection assemblies are provided. Embodiments include a vehicle protection assembly with a composite base, a first organo sheet, and a second organo sheet. Embodiments include the composite base having a first side and a second side that is opposite the first side. Embodiments include the first organo sheet bonded to the first side of the composite base. Embodiments include the second organo sheet bonded to the second side of the composite base.

### INTRODUCTION

The present disclosure relates to vehicles. More particularly, the present disclosure relates to vehicle protection assemblies.

### SUMMARY

Embodiments of the present disclosure advantageously provide vehicle protection assemblies and methods for manufacturing vehicle protection assemblies.

In certain embodiments, a vehicle protection assembly is provided. The vehicle protection assembly includes a composite base having a first side and a second side that is opposite the first side, a first organo sheet bonded to the first side of the composite base, and a second organo sheet bonded to the second side of the composite base.

In certain embodiments, another vehicle protection assembly is provided. The vehicle protection assembly includes an aluminum base, a first organo sheet having a first side and a second side, the first side of the first organo sheet coupled to the aluminum base, a second organo sheet coupled to the second side of the first organo sheet, and an injection molded material bonding the second organo sheet to the first organo sheet.

In certain embodiments, a method of manufacturing a vehicle protection assembly is provided. The method includes heating a stack comprised of an aluminum base, a first organo sheet, and a second organo sheet, placing the stack in a mold cavity, and injecting an injection molded material into the mold cavity, wherein the injection molded material bonds the second organo sheet to the first organo sheet.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1A shows an isometric perspective view an example vehicle, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

It will be readily understood that the components of the embodiments as generally described herein and illustrated in the appended Figures can be arranged and designed in a wide variety of different configurations. Thus, the following more detailed description of various embodiments, as represented in the Figures, is not intended to limit the scope of the present disclosure but is merely representative of various embodiments. While the various aspects of the embodiments are presented in the Figures, the Figures are not necessarily drawn to scale unless specifically indicated.

Electric vehicles are powered by batteries that are typically located near the bottom of the vehicle. Protecting the battery from external conditions and/or impacts is important for a variety of purposes, such as to prevent deformation or intrusion of the battery, which can lead to overheating or thermal runaway, to shield the battery from external temperature swings that can affect performance and charging efficiency, and/or for other longevity purposes. Existing techniques for protecting a battery of an electric vehicle generally involve a vehicle protection assembly, such as a skid plate, which is often a large metal assembly secured to an underside of the electric vehicle.

Aspects of the present disclosure provide improved vehicle protection assemblies that combine organo sheet(s) with a composite and/or aluminum base. For example, one vehicle protection assembly includes two organo sheets that are bonded to a composite base having reinforcement structures, the vehicle protection assembly providing improved mechanical performance (e.g., due to increased stiffness, reduced likelihood of delamination, and greater joint strength), as well as simplified manufacturing and servicing processes (e.g., due to modularity). Another vehicle protection assembly includes two organo sheets that are bonded to an aluminum base, the vehicle protection assembly also providing improved mechanical performance, as well as reduced manufacturing costs (e.g., due to injection molding). In various embodiments, the vehicle protection assemblies may be representative of a skid plate or an underbody component for protecting the battery of the electric vehicle.

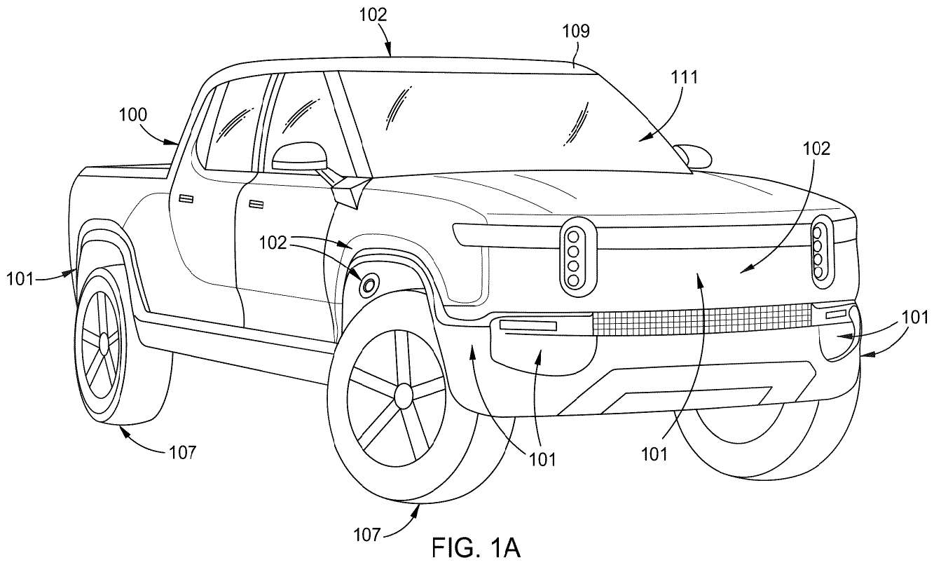

FIG. 1A is a schematic perspective view an example vehicle 100, according to certain embodiments. The vehicle 100 may include multiple sensors 101 and/or multiple cameras 102. The vehicle 100 includes one or more wheel modules 107. The vehicle 100 is an automotive vehicle. In the implementation shown in FIG. 1A, the vehicle 100 is a truck, such as an electric truck. The present disclosure contemplates that the subject matter described herein can be used in any other type of vehicle having any numbers of wheels, such as vans, internal combustion vehicles, and/or sport-utility vehicles (SUVs). The vehicle 100 includes a view panel 111 mounted to a vehicle body 109 of the vehicle 100.

In the embodiment of FIG. 1A and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

According to certain embodiments, the vehicle 100 includes a chassis with a frame for providing a primary structural member of the vehicle 100. The frame may be formed of one or more beams or other structural members or may be integrated with the body of the vehicle (i.e., unibody construction).

In embodiments where the vehicle 100 is a battery electric vehicle (BEV) or possibly a hybrid vehicle, a battery is mounted to the chassis and may occupy a substantial (e.g., at least 80 percent) of an area within the frame. For example, the battery may store from 100 to 200 kilowatt hours (kWh). The battery may be a lithium-ion battery or other type of rechargeable battery. The battery may be substantially planar in shape.

Power from the battery may be supplied to one or more drive units. Each drive unit may be formed of an electric motor and possibly a gear train providing a gear reduction. In some embodiments, there is a single drive unit driving either the front wheels or the rear wheels of the vehicle 100. In another embodiment, there are two drive units, each driving either the front wheels or the rear wheels of the vehicle 100. In yet another embodiment, there are four drive units, each drive unit driving one of four wheels of the vehicle 100.

Power from the battery may be supplied to the drive units by power electronics of each drive unit. The power electronics may include inverters configured to convert direct current (DC) from the battery into alternating current (AC) supplied to the motors of the drive units. The power electronics further facilitate operation of the motors of the drive units as generators to provide regenerative braking. The power electronics further facilitate the transfer of regenerative current to the battery.

The drive units are coupled to two or more hubs to which wheels may mount. Each hub includes a corresponding brake, such as the illustrated disc brakes. Each hub is further coupled to the frame by a suspension. The suspension may include metal or pneumatic springs for absorbing impacts. The suspension may be implemented as a pneumatic or hydraulic suspension capable of adjusting a ride height of the chassis relative to a support surface. The suspension may include a damper with the properties of the damper being either fixed or adjustable electronically.

At an underside of the chassis, a vehicle protection assembly, such as one of the vehicle protection protections assemblies described herein, is secured to the chassis. The vehicle protection assembly is disposed over the battery and protects the battery from external impacts and debris. Adequate protection of the battery is important for decreasing risk of failure, improving longevity, and overall performance of the battery, as well as the vehicle 100.

According to certain embodiments, the vehicle 100 can include a vehicle protection assembly for the underside of the chassis. The vehicle protection assembly includes a composite base as well as a first organo sheet and a second organo sheet (organo sheets).

The composite base is generally made of a combination of one or more fibers (e.g., a thermoplastic polymer) and a resin matrix for holding the fiber(s) together. Examples of fiber(s) include carbon fibers, glass fibers, and/or other suitable fibers. Examples of the resin matrix include thermoset resins (e.g., unsaturated polyester resin (UPR), epoxy resin, vinyl ester resin, etc.), thermoplastic resins (e.g., polypropylene (PP), polyamide (PA), etc.), and/or other suitable resins. In various embodiments, the composite base has a thickness of 1 millimeters (mm) to 6 mm (e.g., 1.5 mm to 5.5 mm, 2 mm to 5 mm, or 2.5 mm to 5 mm). In certain embodiments, the thickness of the composite base is greater than a thickness of the first organo sheet and a thickness of the second organo sheet.

The composite base includes a first side and a second side (sides). The first side faces the first organo sheet and the second side, which is opposite the first side, faces the second organo sheet. The composite base further includes a plurality of reinforcement structures formed on the first side. The reinforcement structures extend from the first side towards the first organo sheet, and have a height of 1 mm to 5 mm (e.g., 1.2 mm to 4.8 mm, 1.4 mm to 4.6 mm, or 1.6 mm to 4.4 mm).

The organo sheets are generally made of a combination of one or more fibers, which can be woven or laminated, and a thermoplastic matrix for holding the fiber(s) together. In other words, the organo sheets can be made of multiple unidirectional endless fiber tapes that are stacked in a different or same orientation, forming a fiber matrix. Examples of the fiber(s) include carbon fibers, glass fibers, aramid fibers (e.g., Kevlar), and/or other suitable fibers. Examples of the thermoplastic matrix include PP, PA, polyetheretherketone (PEEK), polycarbonate (PC), and/or other suitable matrices.

In some embodiments, the organo sheets include multiple layers, each layer generally having a thickness of 0.1 mm to 0.3 mm. In various embodiments, each of the layers can have one or more fills (e.g., glass fill, resin fill, carbon fiber fill, etc.), and can differ in impregnation resins, providing unique properties to different layers. In various embodiments, the first organo sheet and/or the second organo sheet have a thickness of 0.05 mm to 3.5 mm (e.g., 0.06 mm to 3.4 mm, 0.07 mm to 3.3 mm, or 0.08 mm to 3.2 mm). In certain embodiments, the thickness of the first organo sheet may be the same as, or different from, the thickness of the second organo sheet.

The first organo sheet includes a first section, a second section, a third section, and a fourth section (sections). The sections of the first organo sheet are configured to be bonded to (or coupled with) the first side of the composite base. That is, an inner side of the sections bonds with the first side of the composite base.

The second organo sheet also includes a first section, a second section, a third section, and a fourth section (sections). The sections of the second organo sheet are configured to bond with the second side of the composite base, for example, in a manner similar to the first organo sheet. That is, an inner side of the sections bonds with the second side of the composite base.

In certain embodiments, one or more outer layers are disposed over an outer side of the first organo sheet and/or an outer side the second organo sheet. For example, a first outer layer can be formed over the outer side of the first organo sheet, and a second outer layer can be formed over the outer side of the second organo sheet.

According to certain embodiments, the first organo sheet of the vehicle protection assembly is bonded (or molded) to the composite base. To bond the first organo sheet to the composite base, a heat press is pressed against an outer layer. The outer layer is disposed over the first organo sheet, such that the first organo sheet is disposed between the outer layer and the composite base. In various embodiments, the outer layer is made of a material that has a higher melting point than the first organo sheet (e.g., polyethylene terephthalate (PET) or polyamide 66 (PA66)), but still allows for heat to transfer through conduction. The higher melting point of the outer layer reduces the degree to which the heat press sticks to the outer layer. As an example, a melting point of the outer layer is at least 50 degrees Celsius (C) greater than a melting point of the first organo sheet.

In some embodiments, when a thickness of the first organo sheet is less than 2 mm, a thickness of the outer layer is greater than or equal to 25 microns. In other embodiments, when a thickness of the first organo sheet is from 2 mm to 4 mm (e.g., 2.1 mm to 3.9 mm, 2.2 mm to 3.8 mm, or 2.3 and 3.7 mm), the thickness of the outer layer is greater than or equal to 50 microns.

The heat press can be operated at a temperature of 200 °C to 230 °C (e.g., 202 °C to 228 °C, 204 °C to 226 °C, or 206 °C to 224 °C). When the heat press is pressed against the outer layer, the heat press heats the outer layer and the first organo sheet, causing the first organo sheet to bond with the composite base. In other words, the heat from the heat press causes the first organo sheet to at least partially melt over the reinforcement structures and onto the first side of the composite base. A similar bonding technique may also be implemented to bond the second organo sheet to the second side of the composite base.

Using the bonding technique allows flat organo sheets to be used as the organo sheets (without pre-processing). Bonding the organo sheets to the composite base also prevents delamination of the organo sheets from the composite base. Further, bonding the organo sheets eliminates the need for an adhesive to hold the organo sheets to the composite base, and eliminates the need for compression limiters and/or collars, which reduces costs associated with manufacturing the vehicle protection assembly.

Bonding the organo sheets to the composite base also improves the mechanical performance of the vehicle protection assembly. For example, the organo sheets reinforce the composite base by allowing loads to be distributed across a larger area, and by resisting bending or deformation due to the resulting vehicle protection assembly having greater sectional inertia. In other words, the organo sheets carry tensile loads, resist cracking and/or fatigue, and can absorb and dissipate energy more effectively than the composite base alone.

According to certain embodiments, the vehicle protection assembly includes a first module, a second module, a third module, and a fourth module (modules). The modules may also be referred to herein as “regions” of the vehicle protection assembly. Each of the modules includes corresponding sections of the organo sheets. For example, the first module includes the first section of the first organo sheet and the first section of the second organo sheet, the second module includes the second section of the first organo sheet and the second section of the second organo sheet, and so forth.

In some embodiments, the composite base is made of a singular body, such that each of the modules further includes a corresponding portion of the singular body of the composite base. In another embodiment, the composite base is a multi-piece body, such that the composite base is made of a plurality of sections similar to the organo sheets, and each of the modules further includes a corresponding section of the multi-piece body of the composite base.

Each of the modules includes a plurality of brackets. For example, the first module includes a first bracket, a second bracket, a third bracket, and a fourth bracket (brackets). The first bracket and the second bracket are disposed on one side of the first module, while the third bracket and the fourth bracket are disposed on an opposite side of the first module. The brackets extend laterally outwards from the composite base and allow the vehicle protection assembly to be coupled to the underside of a vehicle chassis. Other the modules may also include brackets similar to the first module.

The first module is coupled with the second module by a first coupling feature, a second coupling feature, a third coupling feature, and a fourth coupling feature (coupling features). In some embodiments, when the composite base is a singular body, the coupling features couple the first section with the second section of the second organo sheet. In another embodiment, when the composite base is a multi-piece body, the coupling features couple the first and second sections of the composite base, as well as the first and second sections of the second organo sheet.

In some embodiments, the composite base, the first organo sheet, and/or the second organo sheet may have a different thickness in each of the modules. As an example, for the first module, the corresponding section of the composite base can have a thickness of 3 mm, the first section of the first organo sheet can have a thickness of 1.5 mm, and the first section of the second organo sheet can have a thickness of 2 mm. As another example, for the second module, the corresponding section of the composite base can have a thickness of 4 mm, the second section of the first organo sheet can have a thickness of 1 mm, and the second section of the second organo sheet can have a thickness of 1 mm.

In some embodiments, each of the modules may have a different glass charge, glass fill, or glass type for the first organo sheet and/or the second organo sheet. As an example, for the first module, the first section of the first organo sheet can have a glass charge of 20%. As another example, for the second module, the second section of the first organo sheet can have a glass charge of 10%. As yet another example, for the fourth module, the fourth section of the first organo sheet can have a glass charge of 30%. Other glass charges are also contemplated.

In certain embodiments, the vehicle protection assembly further includes one or more drain channels formed in the composite base and/or the second organo sheet. For example, the drain channel(s) can be formed on the second side of the composite base and/or the inner side of the second organo sheet. The drain channel(s) may be disposed longitudinally and are configured to prevent fluid from remaining within the vehicle protection assembly.

In certain embodiments, the vehicle protection assembly further includes one or more drain apertures formed in the composite base, the first organo sheet, and/or the second organo sheet. For example, the drain aperture(s) can be formed through portions of the composite base, the first organo sheet, and/or the second organo sheet. The drain aperture(s) are configured to prevent fluid from remaining within the vehicle protection assembly.

Integrating the drain channel(s) and/or the drain aperture(s) into the vehicle protection assembly protects against corrosion. For example, the drain channel(s) and/or the drain aperture(s) protect against the creation of galvanic corrosion cells by ensuring fluid and/or poultice is removed from the vehicle protection assembly. In certain embodiments, the drain channel(s) and/or the drain aperture(s) drain fluid and/or poultice from the vehicle protection assembly similar to a sieve.

Further, although the vehicle protection assembly includes four modules, the vehicle protection assembly may also include less than or more than four modules. In certain embodiments, the modules can also be made of multiple layers of steel that are spot welded together. For example, the modules may include three layers of steel instead of the composite base and the organo sheets.

According to certain embodiments, the composite base can include reinforcement structures with different geometric arrangements.

As an example, the reinforcement structures of the first module have a linear geometry, such that the reinforcement structures include a plurality of ribs disposed laterally across the first module. The reinforcement structures of the second module and the third module have a hexagonal geometry, such that the reinforcement structures include a plurality of honeycomb-shaped ribs disposed across the second module and the third module. The reinforcement structures of the fourth module have a grid-like geometry, such that the reinforcement structures include a plurality of square ribs disposed across the fourth module.

Generally, the square ribs in the fourth module provide greater stiffness (or strength) than the ribs and the honeycomb-shaped ribs. Conversely, the honeycomb-shaped ribs provide less stiffness than the ribs and the square ribs.

In certain embodiments, the geometric arrangements of the reinforcement structures for each of the modules is based on potential external impact to the vehicle protection assembly. For example, the first module may be disposed towards the front of the chassis near two front wheel modules 107, while the fourth module may be disposed towards the back of the chassis near the two rear wheel modules 107, and the second and third modules may be disposed between the front and rear wheel modules 107. As such, because the potential external impact is greatest by the two rear wheel modules 107, and lowest between the front and rear wheel modules 107, the modules may have the geometric arrangements.

According to certain embodiments, the composite base can include reinforcement structures having different densities. Each of the modules is shown as having the linear geometry including the ribs, but may also include the honeycomb-shaped ribs, the square ribs, or a combination thereof.

The reinforcement structures of the first module have a medium density, such that each of the ribs in the first module are separated by a distance of at least 35 mm. The reinforcement structures of the second and third modules have a low density, such that each of the ribs in the second and third modules are separated by a distance of at least 40 mm. The reinforcement structures of the fourth module have a high density, such that each of the ribs in the fourth module are separated by a distance of at least 30 mm. Although certain separation distances are provided for the different densities, other distances are also contemplated.

Generally, the high density of the reinforcement structures in the fourth module provides greater stiffness (or strength) than the medium density and the low density. Conversely, the low density of the reinforcement structures in the second and third modules provides less stiffness than the medium density and the high density.

According to certain embodiments, the density of the reinforcement structures for each of the modules is based on potential external impact to the vehicle protection assembly. As such, because the potential external impact is greatest near the two rear wheel modules 107, and lowest between the front and rear wheel modules 107, the modules may have the corresponding densities as described above.

According to certain embodiments, the composite base can include reinforcement structures having different thicknesses. Each of the modules is shown as having the linear geometry including the ribs, but may also include the honeycomb-shaped ribs, the square ribs, or a combination thereof.

The reinforcement structures of the first module have a medium thickness, such that each of the ribs in the first module has a thickness of 3.5 mm to 4.0 mm (e.g., 3.6 mm to 3.9 mm or 3.7 mm to 3.8). The reinforcement structures of the second and third modules have a low thickness, such that each of the ribs in the second and third modules has a thickness of 2.8 mm to 3.5 mm (e.g., 2.9 mm to 3.4 mm, 3.0 mm to 3.3 mm, or 3.1 mm to 3.2 mm). The reinforcement structures of the fourth module have a high thickness, such that each of the ribs in the fourth module has a thickness of 4.0 mm to 5.5 mm (e.g., 4.1 mm to 5.4 mm, 4.2 mm to 5.3 mm, or 4.3 mm to 5.2 mm). Although certain ranges are provided for the different thicknesses, other ranges are also contemplated.

Generally, the high thickness of the reinforcement structures in the fourth module provides greater stiffness (or strength) than the medium thickness and the low thickness. Conversely, the low thickness of the reinforcement structures in the second and third modules provides less stiffness than the medium thickness and the high thickness.

According to certain embodiments, the thickness of the reinforcement structures for each of the modules is based on potential external impact to the vehicle protection assembly. As such, because the potential external impact is greatest near the two rear wheel modules 107, and lowest between the front and rear wheel modules 107, the modules may have the corresponding densities as described above.

Although the reinforcement structures for each of the modules are described as having a corresponding geometric arrangement, density, and thickness, the reinforcement structures of the modules may have any combination of different geometric arrangements, densities, and/or thicknesses.

According to certain embodiments, the composite base is made of a multi-piece body, such that the first module can be separated from the second module.

The first module includes a first receiving portion and a first protruding portion. Similarly, the second module includes a second receiving portion and a second protruding portion. As an example, the second receiving portion of the second module is configured to receive the first protruding portion of the first module. Thus, to form the first coupling feature, the first protruding portion of the second module is mated with the second receiving portion of the second module. A bolt can be used to secure the first and second modules together, but the first and second modules can also be secured together via a snap-fit or other suitable securing mechanism.

The first and second modules include additional receiving portions and protruding portions similar to the first and second receiving portions and the first and second protruding portions. In certain embodiments, the third and fourth modules, may also each include protruding portions and receiving portions similar to the first and second modules. Thus, a similar coupling mechanism may be used to couple the third module with the second module, and the fourth module with the third module.

The modularity of the vehicle protection assembly described above reduces press tonnage when manufacturing the modules. For example, the tonnage needed by a press to manufacture each of the modules individually (e.g., in a multi-piece body embodiment) may be less than the tonnage needed by the press to manufacture the modules collectively (e.g., in a singular body embodiment), which reduces manufacturing costs. The modularity of the vehicle protection assembly also allows for the individual servicing of each of the modules. In other words, when one or more of the modules has been damaged or needs to be replaced, the module(s) can be serviced independently from one another, without having to replace the entire vehicle protection assembly. Such serviceability further reduces risks and labor associated with replacing the module(s).

According to certain embodiments, another example vehicle protection assembly can include a stack for the underside of the chassis. The stack includes an aluminum base as well as a first organo sheet and a second organo sheet (organo sheets).

The aluminum base includes an inner side that faces the first organo sheet, and an outer side. The aluminum base is generally made of one or more metallic alloys (e.g., aluminum alloy, silicon alloy, magnesium alloy, copper alloy, zinc alloy, etc.). In various embodiments, the aluminum base has a thickness of 1.0 mm to 2.0 mm (e.g., 1.1 mm to 1.9 mm, 1.2 mm to 1.8 mm, or 1.3 mm to 1.7 mm). In certain embodiments, the thickness of the aluminum base is greater than a thickness of the first organo sheet and a thickness of the second organo sheet.

The organo sheets are generally made of a combination of one or more fibers and a thermoplastic matrix, for example, similar to the organo sheets described above. In various embodiments, the first organo sheet and/or the second organo sheet have a thickness of 0.05 mm to 3.5 mm (e.g., 0.06 mm to 3.4 mm, 0.07 mm to 3.3 mm, or 0.08 mm to 3.2 mm). In certain embodiments, the thickness of the first organo sheet may be the same as, or different from the thickness of the second organo sheet.

The first organo sheet includes a first side and a second side (sides). The first side faces the aluminum base and the second side, which is opposite the first side, faces the second organo sheet. The first side of the first organo sheet is configured to be coupled with the aluminum base, and the second side of the first organo sheet is configured to be coupled with the second organo sheet.

The second organo sheet includes an inner side that faces the first organo sheet, and an outer side. The inner side of the second organo sheet is configured to be coupled with the second side of the first organo sheet. In certain embodiments, one or more outer layers are disposed over the outer side of the second organo sheet, for example, similar to the outer layer.

In certain embodiments, to bond the first organo sheet to the aluminum base, the stack is placed in a heater. The heater can be operated at a temperature of 200 °C to 230 °C (e.g., 202 °C to 228 °C, 204 °C to 226 °C, or 206 °C to 224 °C). The heater heats the organo sheets, causing the second organo sheet to bond with the first organo sheet, and the first organo sheet to bond with the aluminum base. In other words, the heat from the heater causes the organo sheets to at least partially melt and bond with each other, and causes the first organo sheet to at least partially melt and bond to the aluminum base.

According to certain embodiments, an example vehicle protection assembly includes the stack. The vehicle protection assembly includes the stack, which includes the aluminum base and organo sheets, and an injection molded material. The vehicle protection assembly further includes a plurality of bolt bearing apertures.

The injection molded material is generally made of a thermoplastic material or other moldable composite material (e.g., a glass fiber-reinforced PP such as PPGF30). The injection molded material is molded onto the stack and bonds the second organo sheet to the first organo sheet. As such, the injection molded material is disposed over at least a portion of the aluminum base, at least a portion of the first organo sheet, and at least a portion of the second organo sheet. At least a portion of the injection molded material is also disposed across the second organo sheet. For example, the injection molded material includes a first portion that extends across the second organo sheet, and a second portion that extends partially across the second organo sheet.

The injection molded material can be molded onto the stack by injecting the injection molded material into a cavity holding the stack. The injection of the injection molded material allows for lower press tonnage, which reduces manufacturing costs. Further, the injection of the injection molded material allows for formation of small over-molded features, which eliminates the need for certain post-processing operations. Injecting the injection molded material into the cavity also improves glass fiber distribution across the vehicle protection assembly.

The injection molded material includes additional first and second portions disposed at least partially over the second organo sheet. The vehicle protection assembly may also include a number and/or arrangement of first and second portions that is different from that described above.

In certain embodiments, the vehicle protection assembly further includes one or more drain channels formed in the aluminum base and/or the first organo sheet. For example, the drain channel(s) can be formed on the inner side of the aluminum base and/or the first side of the first organo sheet. The drain channel(s) may be disposed longitudinally and are configured to prevent fluid from remaining within the vehicle protection assembly.

In certain embodiments, the vehicle protection assembly further includes one or more drain apertures formed in the aluminum base, the first organo sheet, and/or the second organo sheet. For example, the drain aperture(s) can be formed through portions of the aluminum base, the first organo sheet, and/or the second organo sheet. The drain aperture(s) are configured to prevent fluid from remaining within the vehicle protection assembly.

According to certain embodiments, the vehicle protection assembly includes the aluminum base, the organo sheets, and the bolt bearing aperture, which is formed as part of a bolt bearing cone. Additionally, the aluminum base includes a flange and a plurality of anchor bores, with which the injection molded material interfaces to secure the injection molded material to the vehicle protection assembly.

The bolt bearing aperture is defined by an opening disposed through at least a portion of the aluminum base and at least a portion of the first organo sheet. Defining the bolt bearing aperture by portions of the aluminum base and the first organo sheet minimizes creep by the injection molded material at the bolt bearing aperture because the first organo sheet holds residual torques better than the injection molded material. The first organo sheet at the bolt bearing aperture also eliminates the need for a compression limiter, which reduces manufacturing costs.

The bolt bearing cone is defined by a partially conical protrusion that includes at least a portion of the aluminum base, at least a portion of the first organo sheet, and at least a portion of the injection molded material. The injection molded material is also formed over the first organo sheet and the second organo sheet, which bonds (or locks) the organo sheets to each other, and to the aluminum base. The second portion of the injection molded material is also disposed over the second organo sheet. Forming the injection molded material over the aluminum base and the organo sheets eliminates the need for an adhesive to bond the layers together and prevents delamination of one or more of the organo sheets from the vehicle protection assembly.

The injection molded material is formed over the flange of the aluminum base. The aluminum base is undercut such that the injection molded material is disposed over the flange, and at least partially over the inner side and the outer side of the aluminum base. By forming the injection molded material over the flange of the aluminum base, the injection molded material prevents the aluminum base from being displaced relative to the injection molded material. In other words, the injection molded material secures to the flange, providing resistance to shear, tension, and/or pull-out forces.

The injection molded material fills the anchor bore. In other words, the injection molded material is disposed through (or occupies) the anchor bore, creating a closed loop around the flange of the aluminum base. By filling the anchor bore, the injection molded material is secured to the aluminum base via an interlocking mechanism, which prevents the injection molded material from separating or breaking away from the aluminum base. Thus, the injection molded material serves as a mechanical anchor, creating a secure bond with the aluminum base and eliminating the need for additional fasteners and/or adhesives.

According to certain embodiments, a technique for manufacturing a vehicle protection assembly is described herein.

At a first operation, the stack, which includes the aluminum base, the first organo sheet, and the second organo sheet, is heated. The stack may be heated in a heater (e.g., an oven). In certain embodiments, the stack is heated until the stack reaches a temperature of 150 °C to 250 °C (e.g., 160 °C to 240 °C, 170 °C to 230 °C, or 180 °C to 220 °C).

At a second operation, the stack is placed in a mold cavity. As an example, the mold cavity forms an area around and/or over the stack into which an injection molded material can be injected. Accordingly, the cavity determines a shape and structure of the injection molded material.

At a third operation, the injection molded material is injected into the mold cavity. The injection molded material bonds the second organo sheet to the first organo sheet, and may also bond the organo sheets to the aluminum base.

In certain embodiments, after the third operation, a plurality of holes are optionally drilled through the aluminum base, the first organo sheet, and the second organo sheet, and the injection molded material. The plurality of holes form the bolt bearing apertures.

In certain embodiments, before the stack is heated at the first operation, a plurality of bores are optionally drilled in the aluminum base, and the aluminum base is undercut. By forming the bores and undercutting the aluminum, the aluminum base is locked with the injection molded material after the injection molded material is injected into the cavity at the third operation.

The present disclosure may be embodied in other specific forms without departing from its spirit. The described embodiments are to be considered in all respects only as illustrative and not restrictive. The scope of the present disclosure is, therefore, indicated by the appended Claims rather than by this Detailed Description. All changes which come within the meaning and range of equivalency of the Claims are to be embraced within their scope.

Reference throughout this specification to features, advantages, or similar language does not imply that all the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the present disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

The foregoing description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein but are to be accorded the full scope consistent with the language of the claims.

What is claimed is:

1. A vehicle protection assembly, comprising:
a composite base having a first side and a second side that is opposite the first side;
a first organo sheet bonded to the first side of the composite base; and
a second organo sheet bonded to the second side of the composite base.

2. The vehicle protection assembly of claim 1, wherein the first side of the composite base comprises a plurality of regions each having a plurality of reinforcement structures.

3. The vehicle protection assembly of claim 2, wherein the plurality of reinforcement structures have different geometric arrangements in at least two of the plurality of regions.

4. The vehicle protection assembly of claim 2, wherein the plurality of reinforcement structures have different densities in at least two of the plurality of regions.

5. The vehicle protection assembly of claim 2, wherein the plurality of reinforcement structures have different thicknesses in at least two of the plurality of regions.

6. The vehicle protection assembly of claim 1, further comprising:
a plurality of drain apertures formed through the composite base, the first organo sheet, and the second organo sheet.

7. The vehicle protection assembly of claim 1, further comprising:
an outer layer,
wherein the first organo sheet is disposed between the outer layer and the composite base.

8. The vehicle protection assembly of claim 1, wherein the vehicle protection assembly comprises a plurality of modules, each module included in the plurality of modules comprising:
at least one section of the composite base that is separate from a section of the composite base in at least one other module;
at least one section of the first organo sheet that is separate from a section of the first organo sheet in at least one other module; and
at least one section of the second organo sheet that is separate from a section of the second organo sheet in at least one other module.

9. The vehicle protection assembly of claim 1, wherein a thickness of the composite base is greater than a thickness of the first organo sheet and a thickness of the second organo sheet.

10. The vehicle protection assembly of claim 1, wherein:
the composite base comprises a thermoplastic polymer; and
the first organo sheet and the second organo sheet comprise at least one of a woven thermoplastic polymer or a laminated thermoplastic polymer.

11. The vehicle protection assembly of claim 1, wherein the vehicle protection assembly comprises an underbody component.

12. The vehicle protection assembly of claim 1, wherein the vehicle protection assembly comprises a skid plate.

13. A vehicle protection assembly, comprising:
an aluminum base;
a first organo sheet having a first side and a second side, the first side of the first organo sheet coupled to the aluminum base;
a second organo sheet coupled to the second side of the first organo sheet; and
an injection molded material bonding the second organo sheet to the first organo sheet.

14. The vehicle protection assembly of claim 13, wherein the injection molded material is disposed over at least a portion of the aluminum base, at least a portion of the first organo sheet, and at least a portion of the second organo sheet.

15. The vehicle protection assembly of claim 13, wherein at least a portion of the injection molded material is disposed across the second organo sheet.

16. The vehicle protection assembly of claim 13, further comprising:
a plurality of bolt bearing apertures defined by:
at least a portion of the aluminum base; and
at least a portion of the first organo sheet.

17. The vehicle protection assembly of claim 13, further comprising:
a plurality of bolt bearing cones defined by:
at least a portion of the aluminum base;
at least a portion of the first organo sheet; and
at least a portion of the injection molded material.

18. A method of manufacturing a vehicle protection assembly, comprising:
heating a stack comprised of an aluminum base, a first organo sheet, and a second organo sheet;
placing the stack in a mold cavity; and
injecting an injection molded material into the mold cavity, wherein the injection molded material bonds the second organo sheet to the first organo sheet.

19. The method of claim 18, further comprising:
forming a plurality of holes through the aluminum base, the first organo sheet, the second organo sheet, and the injection molded material.

20. The method of claim 18, further comprising:
undercutting the aluminum base to lock the aluminum base with the injection molded material.
